(19) United States
(12) Patent Application Publication
(10) Pub. No.: US 2009/0204562 A1
(43) Pub. Date: Aug. 13, 2009

(54) CONFIGURABLE MULTI-LINGUAL ADVISORY SYSTEM AND METHOD THEREOF

(75) Inventors: Chee Weng Wong, Singapore (SG); Tha Nu Maung, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(73) Assignee: NANYANG POLYTECHNIC, Singapore (SG)

(21) Appl. No.: 12/302,802

(22) PCT Filed: Apr. 5, 2007
(86) PCT No.: PCT/SG2007/000093

§ 371 Date: Nov. 28, 2008

(30) Foreign Application Priority Data
Jun. 29, 2006 (SG) 200604434-1

(51) Int. Cl. G06N 5/02

(52) U.S. Cl. 706/47; 706/59; 707/100

(57) ABSTRACT

The present invention provides a configurable multi-lingual advisory system (100). The advisory system include a database (110) a rule builder (120) and a rule analyzer (130). The rule builder (120) operationally receives and processes pre-defined inputs (160) for storing in the database (110). Upon receiving attribute value inputs (170), the rule analyzer (130) processes the attribute value inputs (170) based on the pre-defined input (160) and outputs an advisory report (150) according to an expert domain.

### FIELD OF THE INVENTION

The present invention relates to a data processing system. More particular, the invention relates to a configurable advisory system in any expert domain and the method thereof.

### BACKGROUND

Books and manuals contain tremendous amounts of human knowledge. To gather the knowledge in any expert domain, great amount of time and effort are often spent on reading and interpreting what has to be done to gain the expertise in the field of interest.

With the advancement of computer technology, information processing of knowledge is becoming automated. Advisory systems are now implemented in computer for providing expert knowledge and advices. These “expert” can be mass produced to benefit the public.

Knowledge-based systems, or simply advisory systems, simulate human interpretations of advisory guidelines on computer for providing solution/advisory to problem/issue based on collections of knowledge. Such advisory systems represent expertise knowledge as data or rules. These data and rules can be called upon when needed.

Knowledge-based advisory systems are custom-built systems for a particular domain of expertise. They are generally programs with a specific programming language, which are coded in the forms of decision matrixes. The data containing the knowledge and rules or instructions controlling the output are hard coded and tagged to the decision matrixes. Any changes to advisory rules or to the order of the data of knowledge may cause a cascading chain effect on the nodes in the decision matrix. To modify advisory rules requires re-coding of the entire decision matrix and/or program.

It can thus be seen that there exists a need for a system, which is generic, and yet intelligent to provide easy implementation of an advisory system.

### SUMMARY

In one embodiment, the present invention provides a configurable advisory system for generating an advisory report, the system comprises a database for storing pre-defined data, wherein the pre-defined data is organized and classified as individual entries based on information and functions defined therein; a rule builder operable with the database for receiving and processing pre-defined inputs, and storing the processed pre-defined inputs in the database as the pre-defined data; and a rule analyzer, upon receiving an instruction and attribute value inputs, operable to generate the advisory report based on the pre-defined data, wherein the attribute value inputs is defined based on the pre-defined data, and the instruction includes selections of the entries defined in the pre-defined data.

Preferably, the attribute value inputs are stored in the database as attribute value data. The system may adapt to operate under a plurality of languages, which may be defined under the individual entries of the pre-defined data.

Also, it is preferred that the pre-defined data of the system comprises paragraph entries for defining output texts, attribute entries for defining the attribute value inputs and common rule entries for defining conditions and instructions for operations and outputting an intermediate value. Further each paragraph entry may include a language field for defining the language of the output texts and each paragraph entry may have at least one corresponding paragraph entry with output texts adapted in a language different from that of the paragraph entry. Also, the attribute value inputs may be defined based on the attribute entries, wherein each attribute entry may output at least one of the paragraph entries for acquiring attribute value inputs. Further, each attribute entry may define a data format of the attribute value input where the data format may include float, integer, strings, date and options list. Yet, the conditions and instructions of the common rule entries may include inference rule.

It is also preferred that the pre-defined data further comprises rule entries for defining conditions and instructions for executing one common rule entry. Also, the pre-defined data may further comprise section entries, which comprise one rule entry and at least one paragraph entry for each section entry.

It is further preferred that the pre-defined data further comprises advisory models which include at least one section entry and at least one attribute entry for each advisory model. Accordingly, the advisory report may comprise at least one section entry and at least one attribute entry.

It is also preferred that the pre-defined data is accessible only by a system administrator.

In another embodiment, the present invention provides a method of generating an advisory report comprises inputting pre-defined inputs; processing the pre-defined inputs; storing the pre-defined inputs as pre-defined data in a database, wherein the pre-defined data is organized and classified as individual entries based on information and functions defined therein; providing an instruction and attribute value inputs, wherein the attribute value inputs is defined based on the pre-defined data and the instruction includes selections of the entries defined in the pre-defined data; analyzing the attribute value inputs against the selected entries of the pre-defined data; and generating the advisory report based on the analyzed results.

Preferably, the method further comprises storing the attribute value inputs as attribute value data. The method may further comprise selecting a language for generating the advisory report.

It is also preferred that the step of processing the pre-defined inputs comprises defining paragraph entries containing output texts, defining attribute entries which defines attribute value inputs and defining common rule entries for defining conditions and instructions for operation and outputting an intermediate value. Each paragraph entry may be defined to include a language field for defining the language of the output texts. Also, each paragraph entry may have at least one corresponding paragraph entry with output texts adapted in a language different from that of the paragraph entry. Further, the attribute value inputs may be defined based on the attribute entries. Also, it is preferred that the method further comprises outputting at least one of the paragraph entries defined under each attribute entry for acquiring attribute value inputs. Each attribute entry may also be defined to include a data format of the attribute value input, where data format may include float, integer, strings, date and options list. Also, the method may further comprise defining inference rule as the conditions and instructions of the common rule entries.

It is also preferred that the method further comprises defining rule entries, which defines conditions and instructions for executing one or more common rule entry. The method may also comprise defining section entries, which may comprise one rule entry and at least one paragraph entry for each section entry. The method may further comprise defining advisory models, which may comprise at least one section entry and at least one attribute entry for each advisory model. Preferably, the advisory report comprises at least one section entry and at least one attribute entry.

### BRIEF DESCRIPTION OF THE DRAWINGS

This invention will be described by way of non-limiting embodiments of the present invention, with reference to the accompanying drawings, in which:

FIG. 1 illustrates a schematic block diagram of a configurable advisory system in accordance with an embodiment of the present invention;

FIG. 2 exemplifies semantic of entries used in the configurable advisory system of FIG. 1;

FIG. 3 illustrates a flow diagram of operations of a rule builder of FIG. 1;

FIG. 4 illustrates a flow diagram of operations of generating an advisory report via a configurable advisory system of FIG. 1;

FIG. 5 illustrates a flow diagram of operations of a rule analyzer of FIG. 1;

FIGS. 6a-6p exemplify screenshots of the configurable advisory system of FIG. 1 applied in a clinical decision support system; where,

FIGS. 6a-f are example screenshots of creating a configurable advisory system of FIG. 1 for used in clinical decision support system.

FIGS. 6g-p are example screenshots of processing an advisory report based on the entries created as shown in FIGS. 6a-f.

### DETAILED DESCRIPTION

In the following description, a number of specific and alternative embodiments are provided to understand the inventive features of the present invention. It shall be apparent to one skilled in the art, however that this invention may be practiced without such specific details. Some of the details may not be described at length so as not to obscure the invention. For ease of reference, common reference numerals will be used throughout the figures when referring to the same or similar features common to the figures.

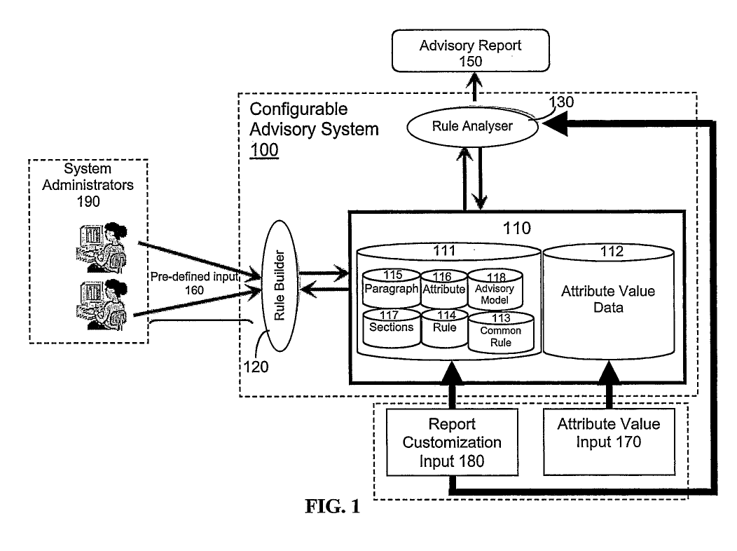

Referring to FIG. 1, there is provided a configurable advisory system 100 in accordance with one embodiment of the present invention. The configurable advisory system 100 includes a database 110, a rule builder 120 and a rule analyzer 130. Briefly, the database 110 is used for storing data, which includes a pre-defined data 111 and an attribute value data 112; the rule builder 120, generally a privileged and controlled process provides a collaborative environment for system administrators 190 to concurrently generate and process pre-defined information for storing in the database 110; and the rule analyzer 130 is adapted for processing and outputting an advisory report 150. Depending on the applications, the configurable advisory system 100 provides a generic system platform adapted to receive input and thereafter outputs an advisory report. To generate advisory reports 150, the database 110 is required to be populated. The pre-defined data 111 and the attribute value data 112 are collections of data in relation to the applications of the configurable advisory system 100. The pre-defined data 111 is a set of preset data, defining the structure, operations/logics, paragraphs and etc. for outputting the advisory report 150. Before the system 100 can be used, the pre-defined data 111 is required to be entered into the database 110. The pre-defined inputs 160 include pre-defined texts in different languages, and rules and guidelines in relation to the nature of the applications. The attribute value data 112 is a database of subject specific records. Each record contains multiple entries in different class. User of the system 100 populates the attribute value data 112 by entering attribute inputs 170 to form records. New records are often entered and existing records are often updated, which makes the attribute data 112 grows in size over time. Upon receiving attribute inputs 170 and/or report customization inputs 180 from the users, an advisory report 150 can be created. While creating the advisory report 150, the configurable advisory system 100 takes the records of the attribute value data 112 to compare with the pre-defined data 111 in generating matched results in the advisory report 150. The customized advisory report 150 is generated automatically. The report customization data 180 refers to user selections of the type of advisory output to be generated in the advisory report 150.

In FIG. 1, the database 110 includes the pre-defined data 111 and the attribute values data 112. It is preferred that the pre-defined data 111 is accessible only by the system administrators 190, whilst the attribute values data 112 is accessible by users of the configurable advisory system 100. The pre-defined data 111 includes a common rule data 113, a rule data 114, a paragraph data 115, an attribute data 116 and a section data 117, an advisory model data 118. The data 113-118 are generally, but not limited to, sets of subject-specified expert knowledge and guidelines for providing expert advisory reports 150. Meanwhile, the pre-defined data 111 are generally stored in the database and does not require frequent maintenances, thus, it is preferred that the pre-defined data 111 is only accessible by the system administrators 190 to avoid unintentional change of the pre-defined data 111 by users. The attribute value data 112, on the other hand, contains records organized in data elements/fields of different classes. The attribute value data 112 archives and indexes the attribute inputs 170 so that users can recall or amend these records should a need arises. The attribute inputs 170 require updates consistently in a manual manner, i.e. user manual input. Preferably, the report customization inputs 180 may also be archived. In an alternative embodiment, the report customization inputs 180 are further archived as templates, herein after referred to as an advisory model 118, which may be used for generating similar advisory report for other records.

Still referring to FIG. 1, the rule builder 120 of the configurable advisory system 100 is adapted to receive the pre-defined inputs 160, which are usually organized in sets of data elements (facts). The rule builder 120 arranges them according to the elements' type and processes the pre-defined inputs 160 for storing and indexing in the pre-defined data 111. When the pre-defined data 111 is populated, an advisory report 150 is generated via the rule analyzer 130 with an appropriate attribute input 170. The rule analyzer 130, upon receiving the report customization input 180, which reference to the pre-defined data 111 generates an advisory report 150 based on the user's selections of the output advices, appropriate to the record of the attribute value data 112. The report customization input 180, in accordance with an alternative embodiment, may be an algorithm, which determines the valid entries of the record and generates an advisory report 150 based on the detected valid entry automatically.

In the above, the “system administrator” 190 refers to any person, who is authorized to access and modify the pre-defined data 111 of the database 110. For any reasons, if the system is to be used to allow any persons, with or without authority, to modify the database 100 at will, the system administrator includes these persons. Similarly, the “user” is referring to a general user, who is given a task to enter inputs 170 for generating an advisory report 150. These users only have the limited access and modified the attribute value data 112 stored in the database 110, and provide the report customization input 180, for generating the advisory report 150. In addition, “accessible” to a person means that the subject is fully controllable, editable, and modifiable by that person. Further, “readable” to a person means that person can only read the subject for its usage, but not alters the subject.

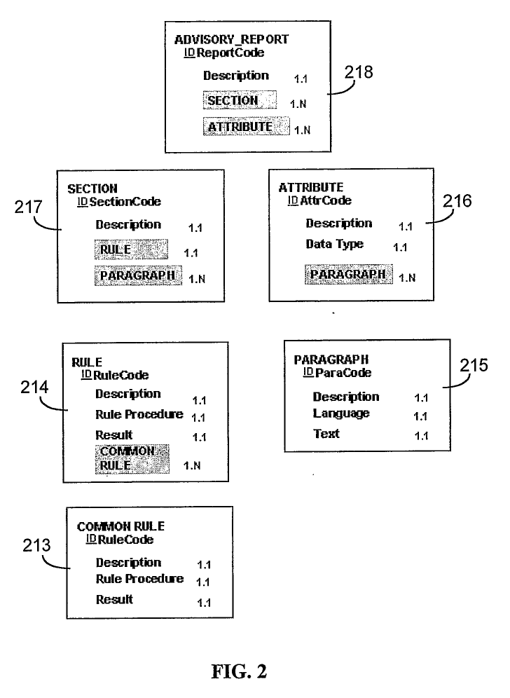

Referring now to FIG. 2, there is provided data structural explanations of possible data entries used in accordance with the present embodiment. The possible type of data entries used including common rule entries 213, rule entries 214, paragraph entries 215, attribute entries 216, section entries 217, and the advisory model 218. In conjunction with FIG. 1, the common rule entries 213 are stored in the common rule data 113, the rule entries 214 are stored in the rule data 114, the paragraph entry 215 are stored in paragraph data 115 and the attribute entries 216 are stored in attribute data 116, the section entries 217 are stored in the section data 117 and the advisory module 218 is stored in the advisory module data 218. Each of the entries has a unique identity (ID), and a description describing the entry. The ID serves at a pointer to which, when the other type of entries referring, refers to the corresponding ID. For the purpose of this description, when one entry is referring to another, only the corresponding ID of the other entry is indicated in that particular entry and not the entire contents of the other entry to which it refers.

In addition, the paragraph entry 215 has a language field and a text field. The language field defines the type of language of the text field and the text field contains strings of text or paragraphs, which are to be displayed to the user or to be outputted on the advisory report 150. Examples of the paragraph entries 215 are shown in Table 1. One of exemplified paragraph entries 215 with ID PA_1 shows a prompt of number of legs in two different languages, i.e. English and Chinese.

Referring again to FIG. 2, the attribute entry 216 contains a data type field and one or more paragraphs 215. The data type field defines the format required for attribute value input, which include float, integer, string value, date and option list. The attribute entry 216 defines the attribute input 170, when the user is prompted, the one or more paragraphs 215 are shown to acquire inputs from the user in the format defined in the data type field. In other embodiments, the data type may be selection of options, which are provided upon prompting. For example, the data elements of the attribute value data 112 are defined by a plurality of attribute entries 216. Example of the attribute entries 216 are shown in Table 1. One of exemplified attribute entries 215 with ID AT_1 shows an attribute which prompts PA_1 for providing an integer value for this attribute entry.

Again in FIG. 2, the common rule entry 213 has a rule procedure field and a result field. The rule procedure field defines conditions and/or logics for operations, whilst the result field defines effects or products of the operations. In other words, the rule procedure field is the cause of the results field. In accordance with the present embodiment, the rule procedure include inference rule, i.e. if-clause and then-clause, which operationally provide results if the conditions and/or logics found to be “true”; for-loop statement, which allows iterative evaluation of codes within the rule procedure; do-while loop or the like. Further, the common rule 213 may contains mathematical formula (s) for outputting mathematical result. The common rule may also contain paragraph entries, if necessary. Examples of the common rule entries 213 are also shown in Table 1. One of exemplified common rule entries 213 ID CR_1 shows rule procedure for testing whether the input variable gets a value “TRUE”. If so, the common true entry 213 returns value “TRUE”.

Once again in FIG. 2, similarly, the rule entry 214 has a rule procedure field and a result field, wherein its rule procedure field defines conditions and logics for outputting values. The output may include operations which trigger/execute one or more common rules 213. The result of evaluation of rule procedure of the common rule entries 213 is returned to rule entry 214. The result is further evaluated by the rule procedure of rule entry 214. Examples of the rule entries 214 are also shown in Table 1. One of exemplified rule entries 214 with ID R_1 shows rule procedure for returning a value “TRUE”. There is no specific rule or condition assigned to this rule procedure as it is intended for this rule to always return a value of “TRUE”.

The section entry 217 contains one rule entry 214 and one or more paragraph entries 215. Similarly, if the rule entry 214 of the section entry 217 returns a positive result, the section entry 217 outputs the one or more paragraph entries 215 therein contained. An advisory report 150 is formed by the output of one or more section entries 217. One of exemplified section entries 217 with ID S_1 used for outputting results.

The advisory model 218 defines the skeleton of the advisory report 150. It contains one or more section entries 217 and one or more attribute entries 216. The advisory model 218 outputs the paragraph entries 215 provided by the section entries 217 with the attribute value input. One of exemplified advisory model 218 with ID AR_1 for prompting AT_1 and AT_2 and outputting S_1 and S_2.

TABLE 1
provides examples of the fields described above.
Paragraph Entries

| ID | Desc. | Language | Text |
|---|---|---|---|
| PA_1 | Prompt for number | English | How many legs does the |
| | of legs. | | animal has? |
| PA_1 | Prompt for number | Chinese | [symbol] ? |
| | of legs | | |
| PA_2 | Prompt for stripe | English | Does the animal has |
| | | | stripes? |
| PA_2 | Prompt for stripe | Chinese | [symbol] ? |
| PA_3 | Output number of | English | Animal has $ATR_1 legs |
| | legs | | |
| PA_3 | Output number of | Chinese | [symbol] $ATR_1 [symbol] |
| | legs | | |
| PA_4 | Output Zebra | English | It is a zebra. |
| PA_4 | Output Zebra | Chinese | [symbol] |

Attribute Entries

| ID | Desc. | Type | Paragraph |
|---|---|---|---|
| AT_1 | Number of legs | Integer | PA_1 |
| AT_2 | Has stripes | Boolean | PA_2 |

Common Rule Entries

| ID | Desc. | Rule Procedure | Result |
|---|---|---|---|
| CR_1 | Test for stripe | If $AT_2=TRUE | TRUE |

Rule Entries

| ID | Desc. | Rule Procedure | Result |
|---|---|---|---|
| R_1 | Output details | | TRUE |
| R_2 | Test for zebra | If $CR_1=TRUE and | TRUE |
| | | $AT_1=4 | |

Section Entries

| ID | Desc. | Rule | Paragraph |
|---|---|---|---|
| S_1 | An animal | R_1 | PA_3 |
| S_2 | A zebra | R_2 | PA_4 |

Advisory Model

| ID | Desc. | Section | Attribute |
|---|---|---|---|
| AR_1 | Advisory | S_1, S_2 | AT_1, AT_2 |
| | template | | |

FIG. 3 shows in a sequential algorithmic of operations for constructing the pre-defined data 111 of FIG. 1 in accordance with one embodiment of the present invention. FIG. 3 is herewith illustrated with reference to FIG. 1. The construction of the pre-defined data 111 is performed by the rule builder 120. At start 300, the configurable advisory system 100 (the rule builder 120) of FIG. 1 prompts and accepts pre-defined input 160. The rule builder 120, in step 310, extracts relevant contents from the pre-defined inputs 160 to form the paragraph entries 215 and store them in paragraph data 115. The language of the paragraph entries 215 is identified in step 310. In step 320, the rule builder 120 further extracts attributes from the pre-defined data 160 to form attribute entries 216. Each of the attribute entries 216 is defined with reference to a corresponding paragraph entry 215 and the type of data. Once the attributes entries 216 are defined, they are stored and indexed in the attribute data 116. At step 330, the advisory rules are generated from the pre-defined input 160. The advisory entries include common rule entries 213 and rule entries 214. In step 330, rule procedures and results of the common rule entries 213 and the rule entries 214 are defined. In step 340, the rule builder 120 generates section entries 217 by reference to appropriate rule entries 214 and appropriate paragraph entries 215. The section entries 217 are then stored and indexed in the section data 117. In step 350, the rule builder 120 defines the advisory models 218, each of which contains one or more attribute entries 216 and section entries 217. The processes 310-350 are repeated to build up a collection of the pre-defined data 111 for the configurable advisory system 100.

FIG. 3 illustrates the operations of creating and generating the pre-defined data 111 according to the present embodiment. It is possible that the constructions of the pre-defined data 111 may not involve all of the step 310-350, but only selective steps. For example, when creating new section entry 217 with existing rule entries 214 and paragraph entries 215 may only involve step 340.

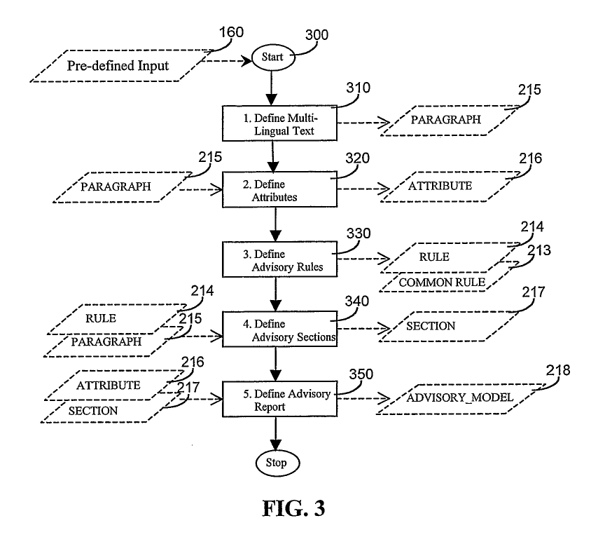

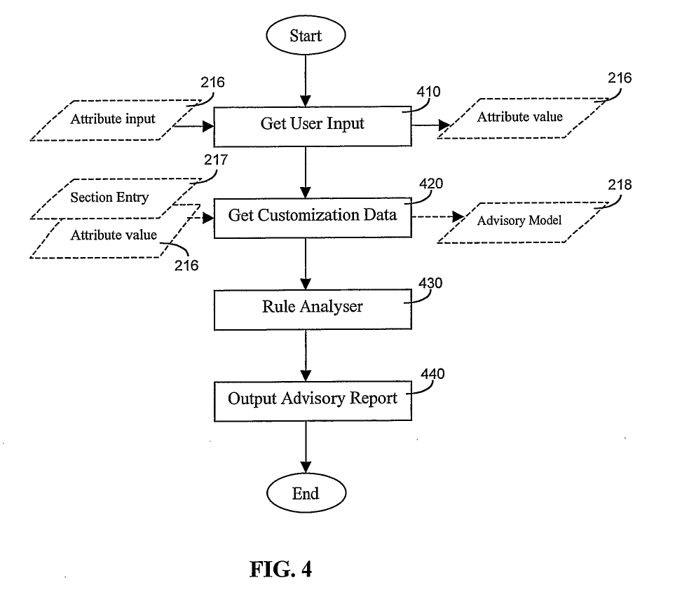

Referring now to FIG. 4, there is provided a flow diagram illustrates operations of generating the advisory report 150. At step 410, user is prompted to provide input data for the attribute entries 216. The acquired data are stored and sorted accordingly in the attribute value data 112. In step 420, the user is prompted to input customization input 180 for customizing the advisory report 150. The customization input 180 includes selections of one or more section entries 217 or the advisory model 218. The report customization input 180, at any point of time, is stored as an advisory model 218 in the advisory data 118. In step 430, the rule analyzer 130 maps the relevant attribute values onto the selections of section entries 217 and/or the advisory module 218 values and outputs the advisory report 150 in step 440.

It is understood that the user may proceed with any of the steps in FIG. 4 without executing the other steps. For example, when the user needs to update the attribute value without generating any advisory report 150, only step 410 is applicable. In a further example, it is possible that the user wishes to generate a customized advisory report 150 based on the stored attribute values, and steps 420-440 are required. Further, the sequence for steps 410 and 420 is interchangeable as long as this two inputs are present.

In accordance with an alternative embodiment of the present invention, the advisory system is configured to provide a relatively simple and straight forward advisory report, or output, for which, storing the attribute value inputs is not required. The advisory system in accordance with the present embodiment may proceed with the step 420 to prompt user for report customization data first, then step 410 to prompt user for attribute value inputs. For that, the user requires to select the relevant common rules and attributes, then input the required attribute inputs to the advisory system. The system then processes the selections and inputs in step 430 and an advisory report, or simply an output is produced.

Referring now to FIG. 5, there is provided a flow diagram illustrating operations of the rule analyzer 130. The rule analyzer 130 starts at step 500 when users' commands are received. These commands include receiving a new report customization input 180 from user, or user selection of a stored advisory module 218 to generate the advisory report 150 for records stored in the attribute value data 112. The rule analyzer 130, in step 510, scans through the inputted/selected advisory module 218 and extracts the attribute entries 216, rules (including common rule entries 213) and section entries 217 from the pre-defined data 111. The rule analyzer 130 reads the attribute value data 112 for the relevant record at step 520. The rule analyzer 130 scans and processes each section entry of the advisory module 218 sequentially at step 530. In the step 540, the rule analyzer 130 executes the rule entries 214 of the section entries 217 against values of that record and generates intermediate rule values 505. At step 550, the rule analyzer 130 performs testing on the relevant records entry against the rule entry 214 (including common rule entry 213) to produce a result in the nature of “yes” or “true”, which means the relevant entry is valid or satisfied; or “no” or “false”, which means the user input parameters in invalid or unsatisfied. If valid, step 560 is performed. If the result is invalid, step 555 is performed. In step 560, the advisory section's paragraph is appended. In step 570 subsequently, the intermediate rule value and the attributes are inserted into the appended paragraphs, if necessary. The rule analyzer 130, in step 580, checks whether more sections are available. If in the affirmative, i.e. more section entries 216 available, the rule analyzer loops back to step 530 to process the next section entries 216 and steps 540-580 are repeated sequentially. Back to the step 550, if the result is in-valid, step 555 is performed to indicate the rule result is “false”. Step 555, when necessary, the system may prompt the user for reason of that invalid result, for example, the relevant attribute value is not present. After the step 555, the operation proceeds to step 580 to check if there are further section to process. If there is none, the operation ends, and the advisory report 150 is generated.

Example 1 exemplifies the operations of FIGS. 4 and 5 with the examples listed in Table 1. It is understood that for establishing a advisory system via the configurable advisory system 100, it requires more entries 213-218. The examples in Table 1 is provided by way of illustration, not limitations. Further, this advisory system does not require the system to store any inputs.

The examples in Table 1 is an multi-lingual advisory system for determining the species of an animal based on the input values and conditions. The advisory system is adapted to provide two languages. In this example, the advisory model AR_1 is selected at step 420, which output section entries S_1 and S_2 by acquiring attribute values required by attribute entries AT_1 and AT_2.

At step 410, the user is first prompted to input a type of prefer language. The two choices is English and Chinese. For illustrating purpose, the selected language for the present language is English. Therefore, the system will prompt the relevant paragraph entries with “English” in the language field. Likewise when in the selected language is “Chinese”. It is also preferred that the user may select/change the preferred language along the processing. A window (not shown) prompts users for inputting attribute values for attribute entries AT_1 and AT_2. The AT_1 prompts by displaying paragraph PA_1, “How many legs does the animal has?”, and AT_2 prompts by displaying PA_2, “Does the animal has stripes?”. For AT_1, the user is required to input integer input and for AT_2, Boolean input “Yes” or “No” is required. For illustrating, the input for AT_1 is 4, and the input for AT_2 is “Yes”. Once the input for step 410 and 420 is obtained, the inputs are processed against the pre-defined data 111 in step 430.

In step 510, the advisory system loads the S_1 and S_2 for processing with the attribute values “4” and “Yes”. As mentioned, the system does not required to store input data. Therefore, step 520 is passed over. In step 530, S_1 is processed by executed R_1, which returns an intermediate value “TRUE” in step 540. The intermediate value “TRUE” is being evaluated in step 550, and proceed to the step 560. The paragraph entry PA_3, “The animal has $AT_1 legs”, is outputted in the advisory report where “$AT_1” is the attribute value input 4 and the value 4 is inserted into the paragraph PA_1 and accordingly resulting output is “The animal has 4 legs”. The operation then proceed to check if AR_1 contains more sections in step 580 and in this case, the operation loops back to step 530 to process S_2.

In step 530, the R_2 of S_2 is executed for evaluating if the common rule $CR_1 has a value of “TRUE” and $AT_1 has a value of 4. Accordingly, the CR_1 is being evaluated if $AT_2 has a value of “TRUE”. As provided above, as $AT_2 returns “TRUE” for $CR_1, and $AT_1 has a value of 4, R_2 returns a value “TRUE”. Accordingly, PA_4 is being outputted as “It is zebra.” As AR_1 does not have any further section entry, the system output the advisory report as: “The animal has 4 legs. It is a zebra.”

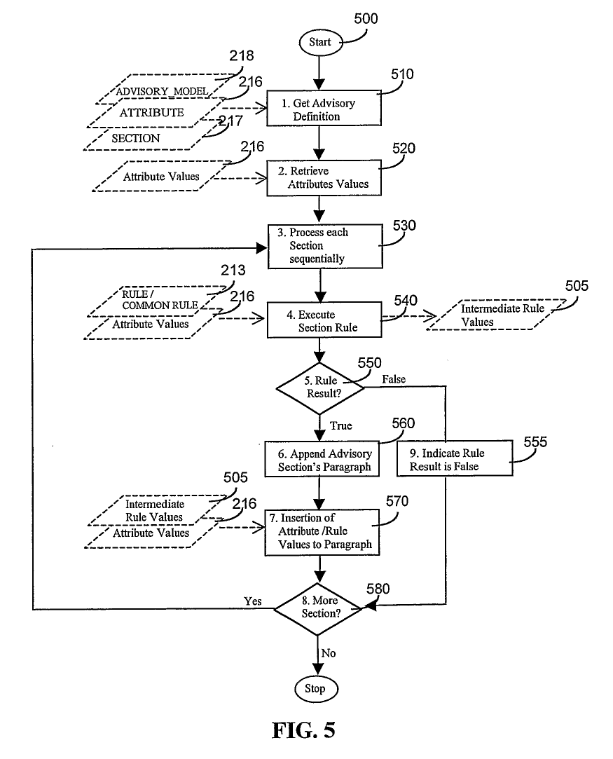

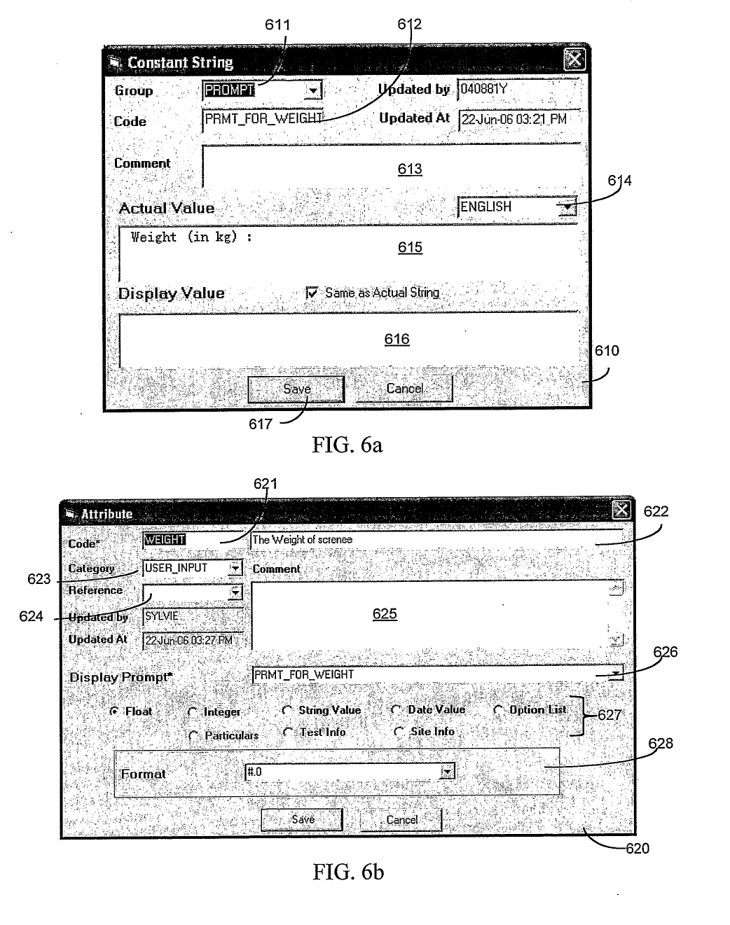

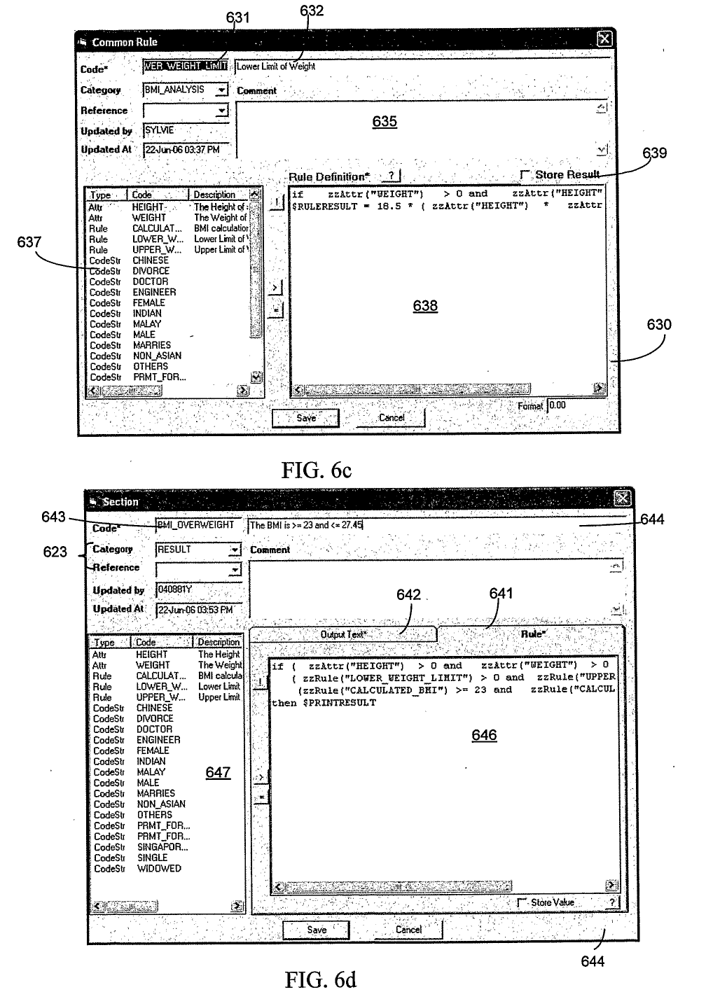

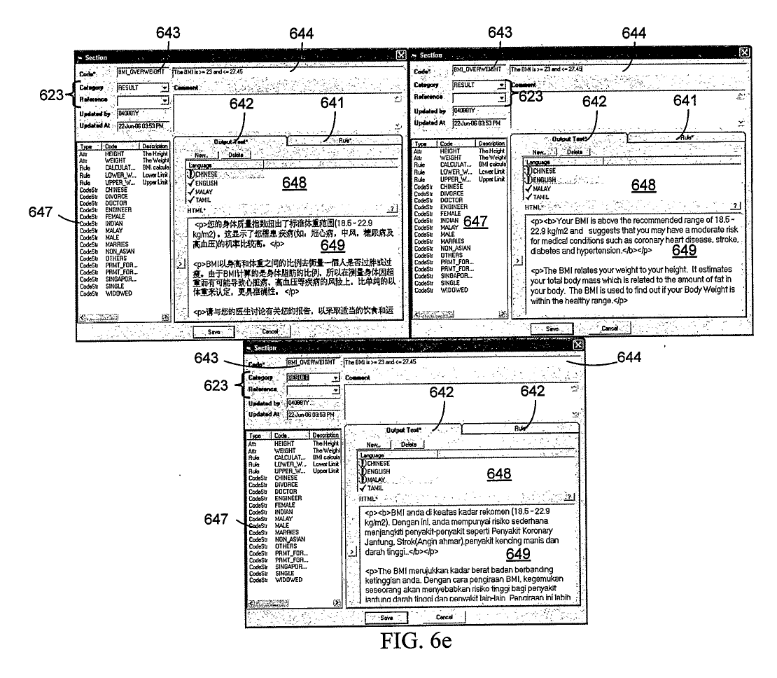

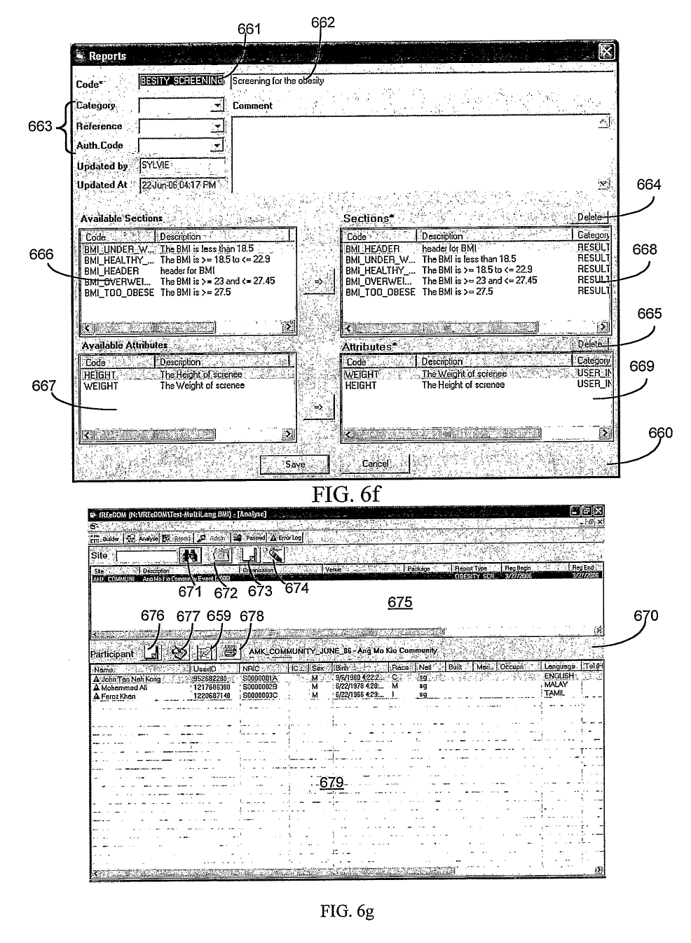

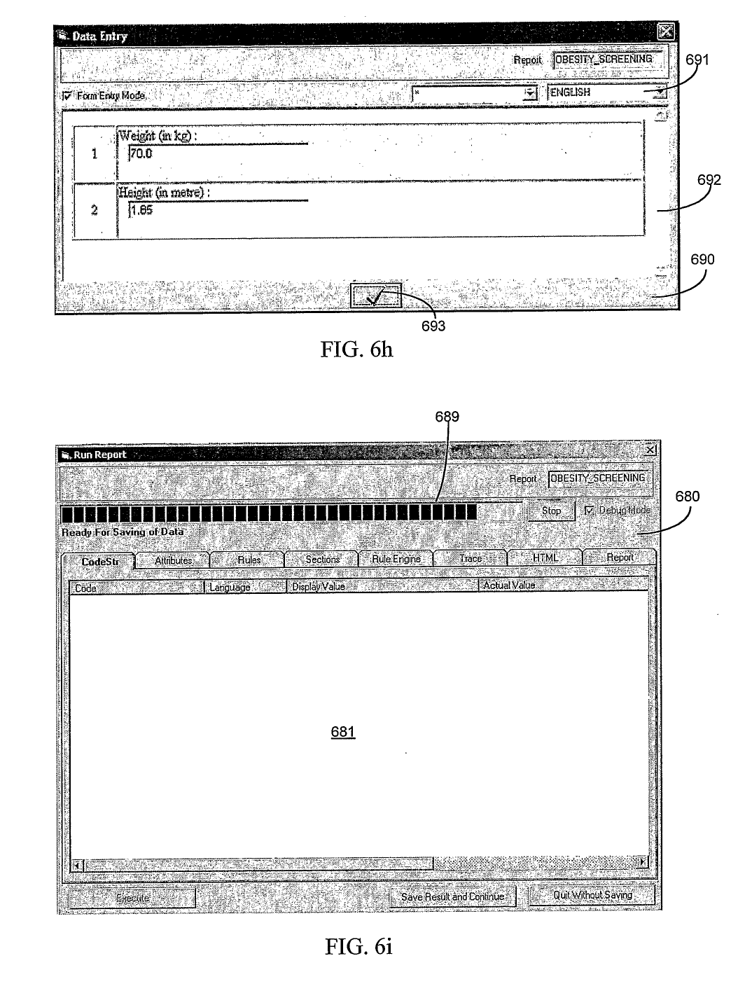

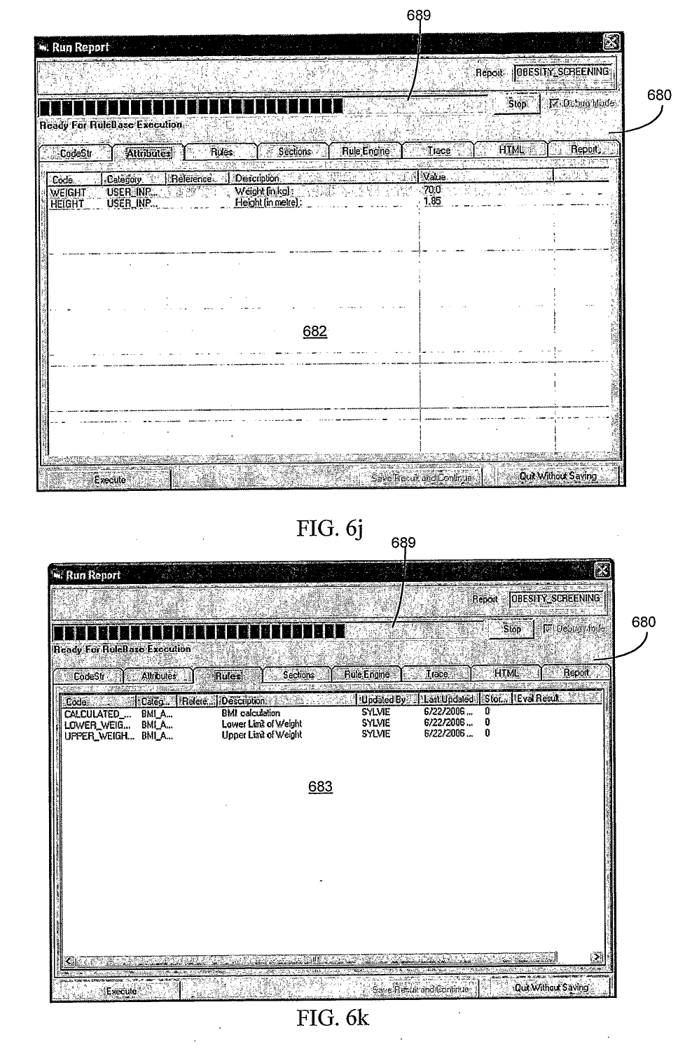

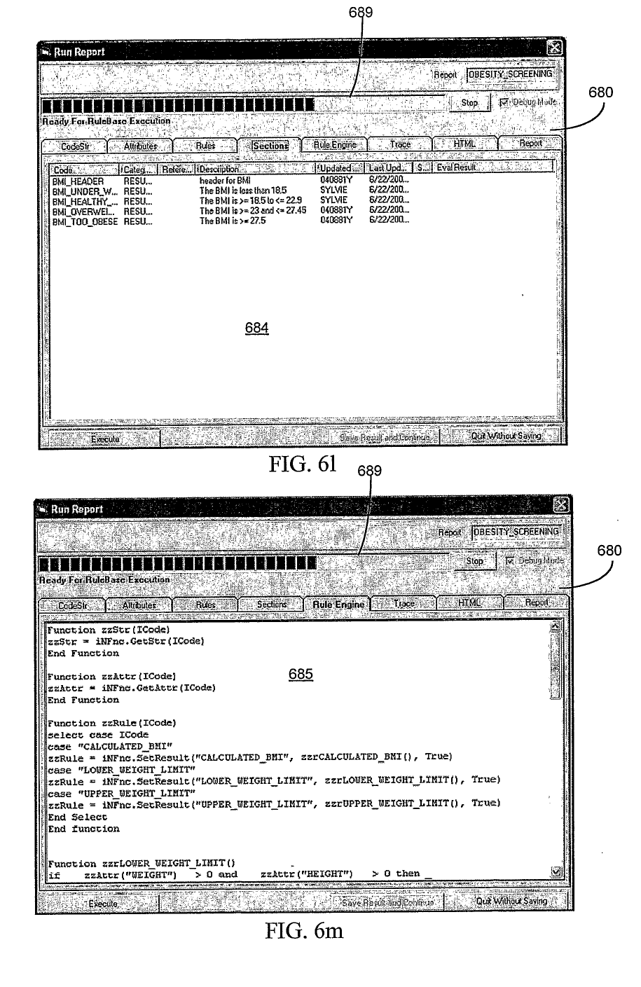

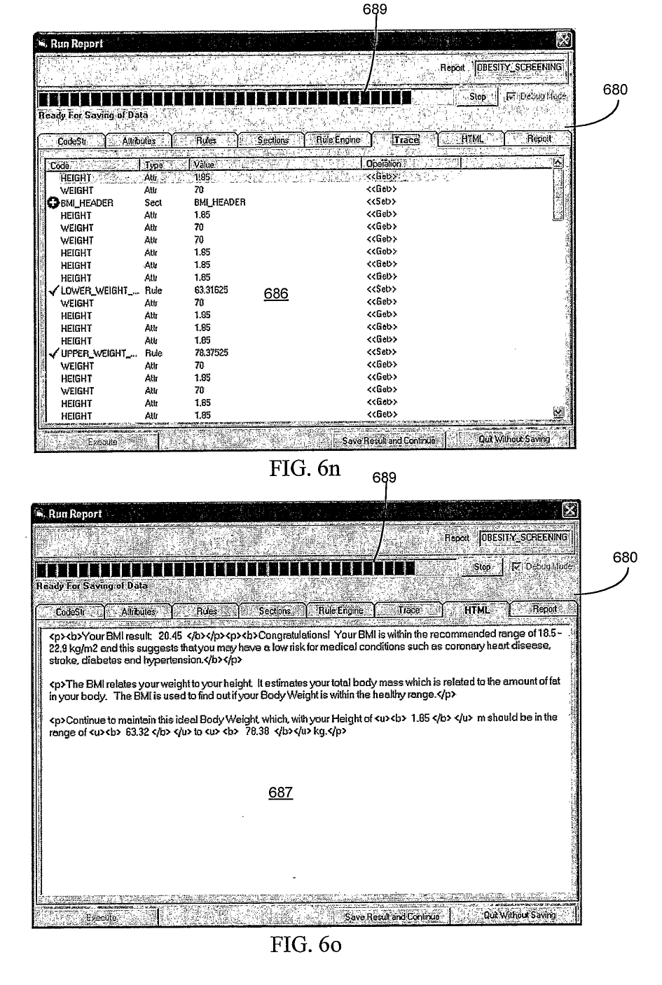

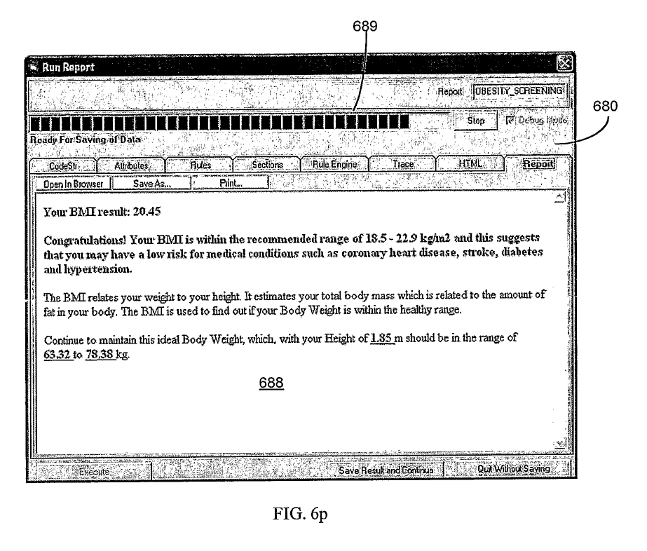

FIGS. 6a-6p are screenshots of the configurable advisory system 100 applicable in a clinical decision support system. Briefly, FIG. 6a shows a screenshot for an constant string window 610, where the paragraph entry 215 is created therein; FIG. 6b shows a screenshot of an attribute window 620, where the attribute entry 216 is created therein; FIG. 6c shows a screenshot of a common rule window 630, where the common rule entry 213 is created therein; FIG. 6d shows a screenshot of a section window 640, where a “rule” tab 641 is active to allow the system administrator 190 to input logic of rule entry 214; FIG. 6e shows screenshots of the section window 640, where a “output text” tab 642 is active, each screenshot shows the entered texts in three languages respectively, and the section entry 217 is created therein; FIG. 6f shows a screenshot of a advisory report window 660, where the advisory model 218 is created therein; FIG. 6g shows a selection window 670, whereby a stored advisory model 218 and the attribute values can be retrieved from, for generating an advisory report 150; FIG. 6h shows a Data Entry window 690, where the system 100 prompts user for attribute value inputs; FIG. 6i shows a Run Report window 680 with a “CodeStr” tab 681 active, showing details of the code string; FIG. 6j shows the Run Report window 680 with a “attribute” tab 682 active, showing details of the attributes; FIG. 6k shows the Run Report window 680 with a “rules” tab 683 active, showing details of the rules (including common rules); FIG. 61 shows the Run Report window 680 with a “sections” tab 684 active, showing details of the section entries; FIG. 6m shows the Run Report window 680 with a “rule engine” tab 685 active, showing details of the all applicable the rules for advisory model FIG. 6n shows the Run Report window 680 with a “trace” tab 686 active, showing results and step-by-step execution of the rule logic; FIG. 6o shows the Run Report window 680 with the HTML tab 687 active, showing the generated advisory report in hyper text markup language; FIG. 6p shows the Run Report window 680 with a “report” tab 688 active, showing details of generated advisory report.

In FIG. 6a, the constant string window 610 is organized in selectable fields and fill-in fields for creating the paragraph entry 215. A Group field 611 is a key-in and drop down box of options for identifying the group of this paragraph entry 215. The available options for the Group field 611 are prompt or other definable group entry. User is allowed to key-in text in the Group field 611, when desired. Right beneath the Group field 610, is a Code field 612, which is provided for the system administrator 190 to assign an ID for this paragraph entry. If desired, comments or descriptions may be entered into a comment field 613. A language selection field 614 is provided for the system administrator 190 to identified the language of this paragraph entry, and following this, the system administrator 190 may enter the texts of desired in an Actual Value field 615. The contact string window 610 provides two separate fields 615 and 616 for entering texts, of which, the system administrator 190 may choose to display texts in the Display Value field 616 rather than the texts entered in the Actual value field 615. As shown in the screenshot, this is a paragraph field for prompting user with text “Weight (in kg):)” in English”. The system administrator 190 can then save this entry in to the paragraph data 115 by clicking the button 617.

In FIG. 6b, the attribute window 620 is organized in selectable fields and fill-in fields for creating the attribute entry 216. The system administrator 190 assigns an ID for this attribute entry in Code field 621, and a description to this attribute is entered in a field 622. The category type of this attribute entry is selectable in a Category field 623, which is a key-in and drop down box with options of user-definable category. A Reference field 624 is provided for documentary purpose. The Category field 623 and the Reference field 624 are provided for easy categorizing and referencing. If desired, additional comments and description may be entered in a Comment field 625. A Display Prompt field 626 with entry IDs is provided for selections of display text from the paragraph entries 215. A data type field 627 is also provided in the form of check selection for selecting the relevant type. The available selections in the data type field 627 are float, integer, string, date value, option list, particulars test info and site info. An additional panel 628 is provided for further defining formats and options for the data type field 627. This panel 628 changes the available option according to the selection of the data type field 627. In the provided screenshot, this attribute is a prompt for acquiring weight by prompting the text of the paragraph entry 215 having an ID of Prmt_For_Weight, i.e. the text shown in fill-in field 615 of FIG. 6a. This attribute entry 216 specifies that the input is to be in float with one decimal point.

In FIG. 6c, the common rule window 610 is organized in selectable fields and fill-in fields for creating the common rule entry 213. An ID can be assigned to this common rule entry in Code field 631 and its description can be entered in the field 632. A Category field and a Reference field 633 are also provided for documentary purpose. A text box 638 is provided for entering rule logic codes for the operations of this common rule, whilst a selection list 637 is provided for the system administrator's 190 selection for the available entries when coding the common rule entry. A check box 639, if checked, instructs the advisory-system 100 to store the output results as the intermediate rule value. The attribute list 637 is organized in three rows showing the type, the ID code and description of the selectable entries. When necessary, the system administrator may select to enter the corresponding window of the selected entry for details by selecting the button 634. As shown in FIG. 6c, this common rule entry is for defining criteria for calculating body mass index with the code:

if zzAttr(“Height” > 0) and zzAttr(“Weight”)
> 0 then
$RULERESULT =
18.5*(zzAttr(“Height”)*zzAttr(“Height”)),

where,

the above example is an if-then statement that outputs $RULERESULT when the condition zzAttr (“Height”)>0 and zzAttr (“Weight”)>0 is met.

In FIGS. 6d and 6e, the section window 640 is organized in selectable fields and fill-in fields for creating the section entry 217. An ID can be assigned to this section entry in Code field 643 and its description can be entered in the field 644. Two tabs, a Rule tab 641 and an Output Text tab 642, are presented one over another when active. In FIG. 6d, the active tab is the Rule tab 641 which is provided for entering Rule entries 214. The Rule tab 641 provides a text field 646 for entering rule logic codes for operations of this Rule entry. A selection list 647 is available for system administrator 190 selections for the available entries. FIG. 6e, provides three section windows 640 their Output Text tab 642 active. Each of the Output Text tab 642 is organized into one selectable field 648 and one fill-in field 649. The selectable field 648 provides options for selecting language. The fill-in field 649 provides field for the entering of the output text in the selected language. In FIG. 6e, the top left screenshot shows that Chinese is selected at field 648, and the text in Chinese is provided in the field 649. The top right screenshot shows that English is selected at field 648, and the text in English is provided in the field 649. The center bottom screenshot shows that Malay is selected at field 648, and the text in Malay is provided in the field 649. A selection list 647 is provided for the system administrator's 190 selection when coding the rule entry in the Rule tab 641. The attribute list 647 is organized in three rows showing the type, the ID code and description of the selectable entries. As shown in FIGS. 6d, the section entry 217 with an ID of BMI_OVERWEIGHT is for displaying advisory text when the calculated BMI value falls within the range of 23-27.45. The range and conditions for this section is defined in the Rule field 641.

In FIG. 6f, the Report window 660, is organized in selectable fields and fill-in fields for creating the report model 218. An ID can be assigned to this report model 218 in the Code field 661 and description may be provided in a field 662. A Category field, a Reference field and an Auth. Code field collectively as fields 663 are also provided for documentary purpose. A section list 666 and an attribute list 667 are provided for selections of the available section entries and attribute entries. A section field 668 and an attribute field 669 are provided, right beside of the section list 666 and the attribute list 667 respectively, for entering the selection of sections and attributes for this report model. As shown in the screenshot, this advisory model, with an ID of OBESITY_SCREENING is for screening for obesity. Five section entries and two attribute entries are selected from the lists 666 and 667. The two attributes entries are for prompting for input of height and weight respectively. One of the section entries, BMI_HEADER, is selected for displaying the calculated BMI results, and the other four entries, are for evaluating against the BMI result. Upon matching the BMI result with the conditions of the four entries, the paragraphs or the advisory texts of the matched section entry will be displayed on the advisory report. Buttons 664 and 665 are provided for removing the selected sections and attributes respectively, when necessary.

FIGS. 6g-6p exemplify screenshots of generating an advisory report 150. FIG. 6g shows a selection window 670 for starting up the generation of an advisory report 150. The upper portion of the screen is provided for selecting an advisory model 218 of interest. The lower portion of the screen provides a list of test cases for the advisory model 218. Each test case in contains the attribute value record stored in the attribute data. A button 671 is used for searching the available advisory report, and the fill-in field besides the button 671 is for entering the search terms. A button 672 is to retrieve the test cases for a selected advisory model; a button 673 is to create a new customized advisory report; a button 674 is to modify an existing customized advisory model; a button 676 is to create a new test case or record; a button 677 is to edit the existing attribute values; a button 659 is for generating an advisory report based on the selected test case/record and the selected advisory model; a button 677 is for printing the generated report.

FIG. 6h shows a Data Entry window 690 for inputting attribute value for processing the advisory report. In window 690, a drop down field 691 is provided for user selections on the preferred language. The default language is generally the selected language when the advisory model is created. In this case, English is the default language. A field 692 of the window 690 is provided for displaying the attributes' prompt selected in the advisory report. This field displays the paragraph entries specified in the selected attribute entries, and provides an appropriate field for each attribute entry for user input. As shown in the screenshot, the field 692 prompts for weight (in kg) and height (in meter), and the inputs provided by user are 70.0 (kg) and 1.85 (meter) respectively. The user may then select a button 693 to conclude the data entry and the advisory system may start generating an advisory report based on the inputs.

FIGS. 6i-6p show a Run Report window 680 showing screenshots of the configured advisory system 100 when generating the advisory report 150. A status bar 689 shows the processing status of the advisory report generation. If desired, the user may stop the process anytime by selecting a “stop” button right beside the status bar. Locating right beneath the status bar, there is provided a CodeStr tab 681, an Attributes tab 682, a Rules tab 683, a Sections tab 684, a Rule Engine tab 685, a Trace tab 686, a HTML tab 687 and a Report tab 688. The CodeStr tab 681 lists all the code values used in rule procedures for user or system administrator's references. The Attributes tab 682 lists all the selected attribute entries and corresponding values inputted earlier. The Rules tab 683 lists all the rule entries. The Sections tab 684 lists all the required section entries. The Rule Engine tab 685 shows the execution plan of the rules 214 and common rules 213. The Trace tab 686 shows all the values, which are calculated and evaluated in sequence, during the advisory report generation process. The HTML tab 688 provides the output text in an HTML language form, which is suitable for outputting to any internet web browser should the advisory system be implemented as a web application. The Report tab 687 shows the actual text of the generated advisory report in English

In accordance with a further embodiment of the present invention, the configurable advisory system 100 may be connected to other data resources, of which, the attribute data 112, or even the pre-defined data 113, are updated automatically. An example of these shared data resources is the government registers.

While specific embodiments have been described and illustrated, it is understood that many changes, modifications, variations and combinations thereof could be made to the present invention without departing from the scope of the invention.

1. A configurable advisory system for generating an advisory report, the system comprising:
a database for storing pre-defined data, wherein the pre-defined data is organized and classified as individual entries based on information and functions defined therein;
a rule builder operable with the database for receiving and processing pre-defined inputs, and storing the processed pre-defined inputs in the database as the pre-defined data; and
a rule analyzer, upon receiving an instruction and attribute value inputs, operable to generate the advisory report based on the pre-defined data, wherein the attribute value inputs is defined based on the pre-defined data, and the instruction includes selections of the entries defined in the pre-defined data.

2. The system according to claim 1, wherein the attribute value inputs are stored in the database as attribute value data.

3. The system according to claim 1, wherein the system is adapted to operate under a plurality of languages, which are defined under the individual entries of the pre-defined data.

4. The system according to claim 1, wherein the pre-defined data comprising:
paragraph entries for defining output texts;
attribute entries for defining the attribute value inputs; and
common rule entries for defining conditions and instructions for operations and outputting an intermediate value.

5. The system according to claim 4, wherein each paragraph entry include an language field for defining the language of the output texts.

6. The system according to claim 5, wherein each paragraph entry has at least one corresponding paragraph entry with output texts adapted in a language different from that of the paragraph entry.

7. The system according to claim 4, wherein the attribute value inputs are defined based on the attribute entries.

8. The system according to claim 7, wherein each attribute entry outputs at least one of the paragraph entries for acquiring attribute value inputs.

9. The system according to claim 7, wherein each attribute entry defines a data format of the attribute value input.

10. The system according to claim 9, wherein the data format includes float, integer, strings, date and options list.

11. The system according to claim 4, wherein the conditions and instructions of the common rule entries include inference rule.

12. The system according to claim 4, wherein the pre-defined data further comprising rule entries and common rule entries for operations and outputting an intermediate value.

13. The system according to claim 12, wherein the pre-defined data further comprising section entries which comprise one rule entry and at least one paragraph entry for each section entry.

14. The system according to claim 13, wherein the pre-defined data further comprising advisory models which comprise at least one section entry and at least one attribute entry for each advisory model.

15. The system according to claim 13, wherein the advisory report comprising at least one section entry and at least one attribute entry.

16. The system according to claim 1, wherein the pre-defined data is accessible only by a system administrator.

17. A method of generating an advisory report comprising:
inputting pre-defined inputs;
processing the pre-defined inputs;
storing the pre-defined inputs as pre-defined data in a database, wherein the pre-defined data is organized and classified as individual entries based on information and functions defined therein;
providing an instruction and attribute value inputs, wherein the attribute value inputs is defined based on the pre-defined data and the instruction includes selections of the entries defined in the pre-defined data;
analyzing the attribute value inputs against the selected entries of the pre-defined data; and
generating the advisory report based on the analyzed results.

18. The method according to claim 17, further comprising storing the attribute value inputs as attribute value data.

19. The method according to claim 17, further comprising selecting a language for generating the advisory report.

20. The method according to claim 17, wherein the step of processing the pre-defined inputs comprising:
defining paragraph entries containing output texts;
defining attribute entries which defines attribute value inputs; and
defining common rule entries for defining conditions and instructions for operation and outputting an intermediate value.

21. The method according to claim 20, further comprising defining each paragraph entry to include a language field for defining the language of the output texts.

22. The method according to claim 21, wherein each paragraph entry has at least one corresponding paragraph entry with output texts adapted in a language different from that of the paragraph entry.

23. The method according to claim 20, wherein the attribute value inputs are defined based on the attribute entries.

24. The method according to claim 23, further comprising outputting at least one of the paragraph entries defined under each attribute entry for acquiring attribute value inputs.

25. The method according to claim 23, further comprising defining each attribute entry to include a data format of the attribute value input.

26. The method according to claim 25, wherein the data format includes float, integer, strings, date and options list.

27. The method according to claim 20, further comprising defining inference rule as the conditions and instructions of the common rule entries.

28. The method according to claim 20, further comprising defining rule entries and common rule entries which defines conditions and instructions for operations and outputting an intermediate value.

29. The method according to claim 28, further comprising defining section entries, which comprise one rule entry and at least one paragraph entry for each section entry.

30. The method according to claim 29, further comprising defining advisory models, which comprise at least one section entry and at least one attribute entry for each advisory model.

31. The method according to claim 29, wherein the advisory report comprising at least one section entry and at least one attribute entry.
